(19) United States
(12) Patent Application Publication
(10) Pub. No.: US 2011/0229230 A1
(43) Pub. Date: Sep. 22, 2011

(54) FIXING ROLLER, FIXING DEVICE AND IMAGE FORMING APPARATUS

(75) Inventor: Etsuaki Urano, Okazaki-shi (JP)

(73) Assignee: Konica Minolta Business Technologies, Inc., Chiyoda-ku (JP)

(21) Appl. No.: 13/049,198

(22) Filed: Mar. 16, 2011

(30) Foreign Application Priority Data
Mar. 19, 2010 (JP) 2010-063935

(51) Int. Cl. G03G 15/20

(52) U.S. Cl. 399/333

(57) ABSTRACT

A fixing roller for fixing a toner image onto a recording sheet by heat, the fixing roller has a cored bar; an open-cell foam sponge layer provided around the cored bar; and a closed-cell foam sponge layer provided around the open-cell foam sponge layer. A fixing device has the fixing roller, and an image forming apparatus has the fixing device.

This application is based on Japanese Patent Application No. 2010-063935 filed on Mar. 19, 2010, the content of which is incorporated herein by reference.

### BACKGROUND OF THE INVENTION

1. Field of the Invention

The present invention relates to a fixing roller and more particularly, relates to a fixing roller for fixing a toner image to a recording sheet by heat, a fixing device including the fixing roller, and an image forming apparatus including the fixing device.

2. Description of Related Art

An electrophotographic image forming apparatus, such as a printer and a copying machine for forming images by electrophotography incorporates a fixing device for fixing a toner image to a recording sheet by heat. Generally, a fixing device nips a recording sheet between a pair of fixing rollers (one of which is referred to as a heating roller, and the other of which is referred to as a pressing roller) and fixes a toner image thereto by heat applied from the heating roller. Japanese Utility Model Laid-Open Publication No. 5-59474 describes use of a pressing roller constituted by a cored bar, a silicone rubber layer covered on the cored bar, a silicone sponge rubber layer covered on the silicone rubber layer and a mold-release layer provided as a surface layer. Japanese Patent Laid-Open Publication No. 8-54798 describes use of a pressing roller constituted by a cored bar, a silicone sponge rubber layer covered on the cored bar, a high heat-conductivity elastic member covered on the silicone sponge rubber layer and a mold-release layer provided as a surface layer.

In recent years, generally, it is significantly desired to suppress heat generation in a fixing device for energy saving. Therefore, in a fixing device, an induction heater is employed as the heater for the heating roller, and silicone rubber sponge is used as a material for the fixing rollers (a heating roller and a pressing roller).

However, there have been founded problems of such a sponge material in terms of heat resistance performance and durability performance, depending on the structure (open-cell foam or closed-cell foam) thereof. When a sponge material of the open-cell foam structure is used for the fixing rollers, the cells have flexibility and accordingly are resistant to destruction. In this case, however, heated air within the cells is exhausted from the sponge layer by the pressure in a nip portion, and air is newly taken into the cells, thereby degrading the thermal efficiency. On the other hand, when a sponge material of the closed-cell foam structure is used for the fixing rollers, exhaustion of heated air from the cells is prevented, thereby resulting in an achievement of a satisfactory thermal efficiency. In this case, however, the cells have rigidity and accordingly are prone to breakage by the pressure in the nip portion, thereby inducing separation of the sponge layer from other layers.

It is possible to contrive provision of a silicone rubber layer of non-sponge material, but such a silicone rubber layer has poor heat resistance performance and can not contribute to energy saving, even though it is good in durability. Further, the provision of such a silicone rubber layer necessitates increasing the nip width, which involves an increase of the rollers in size. The provision of such a silicone rubber layer also necessitates increasing the pressure on the nip portion, which involves an increase of the fixing device in size and an increase in production cost.

According to Japanese Utility Model Laid-Open Publication No. 5-59474, the lower layer of the pressing roller is a silicone rubber layer of a closed-cell foam structure, and therefore, the silicon rubber layer may separate from other layers while the pressing roller is rotating to apply a pressure. Also, the silicone rubber layer and the silicone sponge rubber layer are deformed to different degrees, thereby causing compressive strains in the sponge rubber layer, which may result in cell fractures. According to Japanese Patent Laid-Open Publication No. 8-54798, the pressing roller has a high heat-conductivity elastic layer on a sponge rubber layer, and significant thermal migration from the heating roller is induced, which obstructs energy saving.

### SUMMARY OF THE INVENTION

A fixing roller according to an aspect of the present invention is a fixing roller for fixing a toner image onto a recording sheet by heat, and comprises: a cored bar; an open-cell foam sponge layer provided around the cored bar; and a closed-cell foam sponge layer provided around the open-cell foam sponge layer.

According to a second aspect of the present invention, a fixing device comprises the fixing roller.

According to a third aspect of the present invention, an image forming apparatus comprises the fixing device.

### BRIEF DESCRIPTION OF THE DRAWINGS

These and other features of the present invention will be apparent from the following description with reference to the accompanying drawings, in which:

FIG. 1 is a schematic structural view of an image forming apparatus (printer);

FIG. 2 is a cross sectional view showing the general structure of a fixing unit; and

FIG. 3 is a cross sectional view of a heating roller.

### DETAILED DESCRIPTION OF THE PREFERRED EMBODIMENTS

Hereinafter, with reference to the accompanying drawings, there will be described a fixing roller, a fixing device and an image forming apparatus according to an embodiment of the present invention.

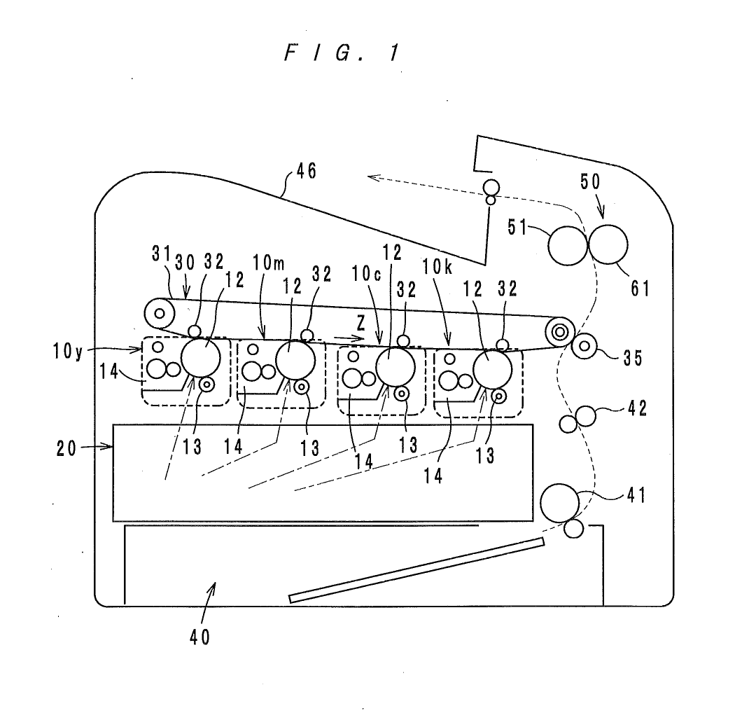

### The Image Forming Apparatus; See FIG. 1

With reference to FIG. 1, an image forming apparatus according to the present invention will be described. The image forming apparatus is a tandem-type color printer, and mainly includes processing units 10 (10y, 10m, 10c and 10k) for forming toner images of respective colors of Y, M, C and K, a laser scanning unit 20, an intermediate transfer unit 30, an automatic sheet feeding unit 40, and a fixing unit 50.

The processing units 10 each include a photosensitive drum 12, a charging roller 13, a development device 14, a cleaner for cleaning residual toner and residual charge, and the like, inside a casing illustrated by a dot line in FIG. 1. In the processing units 10, electrostatic latent images are formed on the photosensitive drums 12 with a laser emitted from the laser scanning unit 20, and the electrostatic latent images are developed into toner images with the development devices 14.

The intermediate transfer unit 30 includes an intermediate transfer belt 31 that is driven to rotate in the direction of an arrow Z in an endless manner. The toner images formed on the respective photosensitive drums 12 are transferred to the intermediate transfer belt 31 through electric fields applied from transfer rollers 32 that are opposed to the respective photosensitive drums 12. This electrophotographic image forming process is well known, and a detailed description thereof is omitted here.

At a lower portion of the apparatus main body, there is placed the automatic sheet feeding unit 40 for feeding recording sheets one by one. A recording sheet is fed through a feeding roller 41 and a timing roller 42 to a nip portion between the intermediate transfer belt 31 and a secondary transfer roller 35, where a toner image (composite color image) is transferred to the recording sheet (secondary transfer). Thereafter, the recording sheet is conveyed to the fixing unit 50, where the sheet is subjected to a heating treatment, so that the toner image is fixed thereon. Thereafter, the recording sheet is ejected onto a tray 46 placed on an upper surface of the apparatus main body.

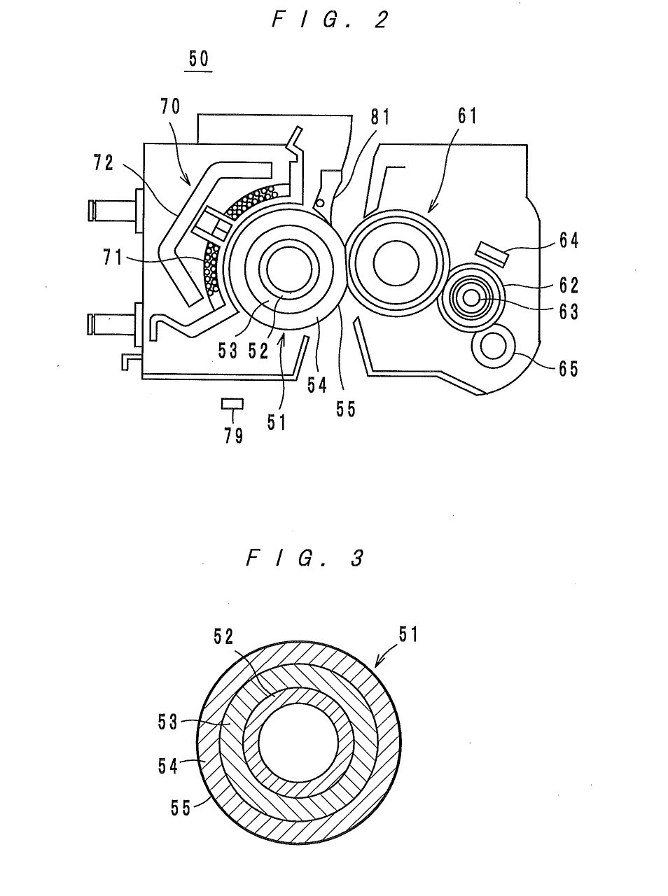

### The Fixing Unit; See FIG. 2 and FIG. 3

The fixing unit 50 is constituted by a heating roller 51 and a pressing roller 61, as illustrated in FIG. 2 (which illustrates no hatching for simplification). The heating roller 51 and the pressing roller 61 are placed in parallel and rotatable with respect to each other. A recording sheet is fed through the nip portion between the rollers 51 and 61 such that its surface with a toner image transferred thereon is faced to the heating roller 51, so that the toner image is fixed thereon by heat. Near the outlet of the heating roller 51, there is placed a separation claw 81 for separating the recording sheet from the heating roller 51 after the fixing process.

An induction heater 70 is disposed around the heating roller 51 so as to heat the heating roller 51 to a predetermined temperature, and a thermopile 79 is disposed near the unit 50 so as to detect the heating temperature. The induction heater 70 is of a well-known type including a magnetic core 72 and a coil serving as a magnetic-flux generating portion 71. The induction heater 70 exerts a magnetic flux on a nickel electroformed layer 55 formed as the surface layer of the heating roller 51, thereby generating heat.

A heat equalizing roller 62 is disposed to be pressed against the pressing roller 61. A halogen lamp 63 is incorporated in the heat equalizing roller 62 as a heat source to heat the heat equalizing roller 62, and thereby, the heat equalizing roller 62 heats a surface of the pressing roller 61 to a predetermined temperature. Near a surface of the heat equalizing roller 62, a non-contact type temperature sensor 64 is placed to detect the temperature thereof. Further, a brush roller 65 is placed in such a manner to be capable of rotating in contact with the heat equalizing roller 62.

A driving force for rotation is transmitted to the pressing roller 61, and accordingly, the heating roller 51 pressed against the pressing roller 61 is driven to rotate. Further, the heat equalizing roller 62 is driven to rotate. Also, the driving force is branched from the pressing roller 61 to the brush roller 65.

Next, the structure of the heating roller 51 will be described, with reference to FIG. 3. The pressing roller 61 has the same structure as that of a conventional one, but may have the same structure as that of the heating roller 51 which will be described later.

The heating roller 51 is constituted by a cored bar 52 as a rotary shaft, an open-cell foam sponge rubber layer 53 provided on the periphery of the cored bar 52, a closed-cell foam sponge rubber layer 54 provided on the periphery of the sponge rubber layer 53, and a nickel electroformed layer 55 provided on the periphery of the sponge rubber layer 54.

The material and the fabrication process of the heating roller 51 will be hereinafter described. A nonmagnetic metal bar with an outer diameter of 20 mm was used as the cored bar 52. The open-cell foam sponge rubber layer 53 was fabricated as follows. The cored bar 52 was set in a first casting die, and open-cell foam silicone rubber was injected in the first casting die, around the cored bar 52. Then, the first casting die was put into an electric furnace, and primary vulcanization was performed. Thereafter, the cored bar 52 with the silicone rubber layer around the periphery was taken out from the first casting die, and then, secondary vulcanization was performed to complete the open-cell foam structure. The primary vulcanization was performed under temperature within a range from 60 to 90 degrees Celsius for 20 to 30 minutes. The secondary vulcanization was performed under temperature within a range from 190 to 230 degrees Celsius for 60 to 120 minutes.

The closed-cell foam sponge rubber layer 54 was fabricated as follows. After the completion of the aforementioned secondary vulcanization, the intermediate product was set in a second casting die, and closed-cell foam silicone rubber was injected into the second casting die, around the open-cell foam sponge rubber layer 53. Then, the second casting die was put into an electric furnace, and primary vulcanization and secondary vulcanization were successively performed, whereby the closed-cell foam sponge rubber layer 54 was formed. Thereafter, the intermediate product was taken out from the second casting die and ground by a grinding machine to have a defined outer diameter. Further, a nickel electroformed sleeve with a thickness of 40 micrometers was provided on a surface of the closed-cell foam sponge rubber layer 54, as the nickel electroformed layer 55.

The open-cell foam sponge rubber layer 53 fabricated as described above had a thermal conductivity within a range from 0.0895 to 0.1334 W/m·° C. The closed-cell foam sponge rubber layer 54 had a thermal conductivity within a range of 0.0734 to 0.1932 W/m·° C.

Various heating rollers 51 that vary in thickness of the open-cell foam sponge rubber layer 53 and in thickness of the closed-cell foam sponge rubber layer 54 were fabricated, and more specifically, the heating rollers 51 were fabricated such that the respective open-cell foam sponge rubber layers 53 and the closed-cell foam sponge rubber layers 54 have thicknesses indicated in examples 1 to 5 in Table 1 below. Then, these various heating rollers 51 were employed in the fixing unit 50 one by one, and the performance of the fixing unit 50 was evaluated. Evaluations were made with respect to heat-up performance, durability performance and temperature decrease, as shown in Table 1. As a comparative example 1, a heating roller with only a closed-cell foam sponge rubber layer on the periphery of a cored bar 52 was used, and as a comparative example 2, a heating roller with only an open-cell foam sponge rubber layer on the periphery of a cored bar 52 was used. The same evaluations were made on these comparative examples 1 and 2.

The performance tests were conducted by using the color printer illustrated in FIG. 1. Specifically, characters with an image density of 20% were printed on an A4-sized sheet of ordinary paper having a basis weight of 64 g/m² under environmental conditions of a temperature of 23 degrees Celsius and of a relative humidity of 65%. In this state, the temperature-rising speed, and the temperature change of the surface of the heating roller 51 during a continuous printing process were detected. The durability tests were conducted by using the fixing unit 50 only. In the fixing unit 50, a pressing force larger than a normal force by 10% was applied between the rollers 51 and 61, and the nickel electroformed layer 55 was heated by the induction heater 70. In this state, it was timed until the sponge rubber layers 53 and 54 fractured.

TABLE 1

| | Sponge Rubber | Thickness | | Heat-Up | Durability | Temperature | Overall | |
|---|---|---|---|---|---|---|---|---|
| | Layer | (mm) | Ratio | Performance | Performance | Decrease | Evaluation | Remarks |
| Comparative | Closed-Cell Foam | 10 | | ◯ | X | ◯ | X | Single Layer of |
| Example 1 | Only | | | | | | | Closed-Cell Foam |
| Comparative | Open-Cell Foam | 10 | | X | ◯ | X | X | Single Layer of |
| Example 2 | Only | | | | | | | Open-Cell Foam |
| Example 1 | Closed-Cell Foam | 2 | 1:4 | ◯ | ◯ | ◯ | ◯ | Upper Layer: |
| | Open-Cell Foam | 8 | | | | | | Closed-Cell Foam |
| Example 2 | Closed-Cell Foam | 3 | 1:2 | ◯ | ◯ | ◯ | ◯ | Sponge |
| | Open-Cell Foam | 7 | | | | | | Lower Layer: |
| Example 3 | Closed-Cell Foam | 5 | 1:1 | ◯ | ◯ | ◯ | ◯ | Open-Cell Foam |
| | Open-Cell Foam | 5 | | | | | | Sponge |
| Example 4 | Closed-Cell Foam | 7 | 1:0.4 | ◯ | ◯ | ◯ | ◯ | |
| | Open-Cell Foam | 3 | | | | | | |
| Example 5 | Closed-Cell Foam | 8 | 1:0.25 | ◯ | Δ | ◯ | Δ | |
| | Open-Cell Foam | 2 | | | | | | |

In Table 1, a circle indicates that the result of the performance test was good, a triangle indicates that the result of the performance test was not good but was no matter for practical use, and a cross indicates that the result of the performance test was too bad for practical use. The examples 1 to 4 were given satisfactory evaluation results in all the tests. This reveals that the thicknesses of the open-cell foam sponge rubber layer 53 and the closed-cell foam sponge rubber layer 54 are preferably at a ratio from 1:4 to 1:0.4. In the case of example 5, the thickness ratio was 1:0.25, and it was found that this example 5 is not unsatisfactory in durability but is practical.

### Other Embodiments

The details of the fixing unit may be arbitrarily designed. Instead of the induction heater, a halogen lamp may be incorporated in the fixing unit as a heat source for the heating roller. In cases where the present invention is applied to a pressing roller, the pressing roller shall be constituted by a cored bar, an open-cell foam sponge rubber layer, a closed-cell foam sponge rubber layer and further a mold-release layer as the surface layer thereof. The mold-release layer is preferably formed from fluorine resin, such as PTFE, PFA, etc. Further, the mold-release layer has a thickness preferably within a range from 20 to 50 micrometers.

According to the embodiments, the fixing roller has a closed-cell foam sponge layer, which provides good thermal insulation, as the surface layer or near the surface layer, and therefore, the fixing roller is good in thermal efficiency. That is, the fixing roller heats up to a fixing temperature quickly, which contributes to energy saving. Also, the fixing roller has an open-cell foam sponge layer, which has flexibility, as an inner layer, and therefore, delamination, which may be caused by pressure/rotation, can be prevented. That is, the fixing roller is good in durability. Thus, the fixing roller is good in thermal efficiency and in durability.

Although the present invention has been described in connection with the preferred embodiments above, it is to be noted that various changes and modifications are possible to those who are skilled in the art. Such changes and modifications are to be understood as being within the scope of the present invention.

What is claimed is:

1. A fixing roller for fixing a toner image onto a recording sheet by heat, the fixing roller comprising:
a cored bar;
an open-cell foam sponge layer provided around the cored bar; and
a closed-cell foam sponge layer provided around the open-cell foam sponge layer.

2. The fixing roller according to claim 1, which functions as a heating roller for heating a recording sheet and/or a pressing roller for pressing a recording sheet against the heating roller.

3. The fixing roller according to claim 1, wherein the open-cell form sponge layer and the closed-cell foam sponge layer are made of silicone rubber.

4. The fixing roller according to claim 1, wherein the closed-cell foam sponge layer and the open-cell foam sponge layer have such thicknesses to be at a ratio within a range from 1:4 to 1:0.25.

5. The fixing roller according to claim 1, wherein the closed-cell foam sponge layer and the open-cell foam sponge layer have such thicknesses to be at a ratio within a range from 1:4 to 1:0.4.

6. The fixing roller according to claim 1, further comprising a fluorine resin layer as an outermost layer thereof.

7. The fixing roller according to claim 1, further comprising a nickel electroformed layer as an outermost layer thereof.

8. A fixing device comprising the fixing roller according to claim 1.

9. The fixing device according to claim 8, further comprising a heater for heating a surface of the fixing roller.

10. The fixing device according to claim 9, wherein the heater is an induction heater.

11. The fixing device according to claim 8, wherein the closed-cell foam sponge layer and the open-cell foam sponge layer of the fixing roller have such thicknesses to be at a ratio within a range from 1:4 to 1:0.25.

12. The fixing device according to claim 8, wherein the closed-cell foam sponge layer and the open-cell foam sponge layer of the fixing roller have such thicknesses to be at a ratio within a range from 1:4 to 1:0.4.

13. An image forming apparatus comprising the fixing device according to claim 8.

14. The image forming apparatus according to claim 13, wherein the fixing device further comprises a heater for heating a surface of the fixing roller.

15. The image forming apparatus according to claim 14, wherein the heater of the fixing device is an induction heater.

16. The image forming apparatus according to claim 13, wherein the closed-cell foam sponge layer and the open-cell foam sponge layer of the fixing roller have such thicknesses to be at a ratio within a range from 1:4 to 1:0.25.

17. The image forming apparatus according to claim 13, wherein the closed-cell foam sponge layer and the open-cell foam sponge layer of the fixing roller have such thicknesses to be at a ratio within a range from 1:4 to 1:0.4.
